(19) United States
(12) Patent Application Publication
(10) Pub. No.: US 2025/0058637 A1
(43) Pub. Date: Feb. 20, 2025

(54) BATTERY, A POWER SYSTEM FOR A VEHICLE, AND A METHOD FOR CONTROLLING THE SAME

(71) Applicants: Hyundai Motor Company, Seoul (KR); Kia Corporation, Seoul (KR)

(72) Inventor: Jin Gi Kim, Seoul (KR)

(21) Appl. No.: 18/775,006

(22) Filed: Jul. 17, 2024

(30) Foreign Application Priority Data
Aug. 14, 2023 (KR) 10-2023-0106231

(51) Int. Cl. B60L 3/00; B60L 53/20; B60L 58/12; H01M 10/42; H01M 10/44

(52) U.S. Cl. CPC B60L 3/0046; B60L 3/0092; B60L 53/20; B60L 58/12; H01M 10/425; H01M 10/441; B60L 2210/10; B60L 2260/26; H01M 2220/20

(57) ABSTRACT

Provided are a battery, a vehicle power system, and a controlling method for the same. A battery may include the first output line, the second output line, the first cell module which includes a plurality of first cells and outputs the first voltage to the first output line, the second cell module which includes a plurality of second cells is connected to the first cell module in series and outputs a second voltage to the second output line; a first switching element which connects the first output line and the first cell module; and a second switching element which connects the second output line and the second cell module.

### CROSS-REFERENCE TO RELATED APPLICATION

The present application claims to the benefit of Korean Patent Application No. 10-2023-0106231, filed on Aug. 14, 2023, the entire contents of which is incorporated herein by reference in its entirety for all purposes.

### BACKGROUND

### Technical Field

The present disclosure relates to a battery, a power system for a vehicle, and a method for controlling the same.

### Background

In general, an electric vehicle includes a high-voltage battery for supplying power to a driving motor, a low-voltage battery for supplying low-voltage power to various electronic devices, and a low-voltage DC-DC converter for converting power of the high-voltage battery into a low voltage.

During driving, a part of the power converted into the low voltage through the DC-DC converter is supplied to the electronic device, and the other part thereof is used to charge the low-voltage battery. In addition, the power of the low-voltage battery is supplied to the electronic devices during parked.

In autonomous vehicles, controllers related to the autonomous driving operate at the low voltage, so safety accidents can occur if problems occur in the low-voltage power supply system.

For this reason, a redundancy low-voltage power system is required for autonomous vehicles to prevent safety accidents from being caused by a failure in power supply to one or more of the controllers.

### SUMMARY

A purpose of the present disclosure is to provide a redundant low-voltage power system and an electric vehicle including the same.

An exemplary embodiment of the present disclosure is to provide a power system capable of supplying emergency power when a problem occurs in a power supply of the low-voltage battery, and an electric vehicle thereof.

According to an exemplary embodiment of the present disclosure, a battery comprises a first output line, a second output line, a first cell module comprising a plurality of first cells and configured to output a first voltage to the first output line, a second cell module comprising a plurality of second cells and connected to the first cell module in serial connection and configured to output a second voltage to the second output line, a first switching element electrically coupling the first output line to the first cell module, and a second switching element electrically coupling the second output line to the second cell module.

In at least one embodiment, the first cell module comprises a first cell set comprising the first cells in serial connection to output the first voltage to the first output line, and the second cell module comprises a second cell set connected to the first cell set in serial connection and comprising the second cells in serial connection to output the second voltage to the second output line.

In at least one embodiment, the first cell set comprises a plurality of first cell sets connected in parallel, and the second cell set comprises a plurality of second cell sets connected in parallel.

According to another embodiment, a power system for a vehicle comprises a first connection line connected to a first low-voltage DC-DC converter and/or a first electronic device, a second connection line connected to a second low-voltage DC-DC converter and/or a second electronic device, a first relay connected to the first connection line, a second relay connected to the second connection line, a control unit configured to control the first relay and the second relay, and a first low-voltage battery, wherein the first low-voltage battery comprises a first output line, a second output line, a first cell module comprising a plurality of first cells and configured to output a first voltage to the first output line, a second cell module comprising a plurality of second cells and connected to the first cell module in serial connection and configured to output a second voltage to the second output line.

In the power system of at least one embodiment of the present disclosure, the first cell module comprises a first cell set comprising the first cells in serial connection to output the first voltage to the first output line, and the second cell module comprises a second cell set connected to the first cell set in serial connection and comprising the second cells in serial connection to output the second voltage to the second output line.

In the power system of at least one embodiment of the present disclosure, the first cell set comprises a plurality of first cell sets connected in parallel, and the second cell set comprises a plurality of second cell sets connected in parallel.

In the power system according to at least one embodiment of the present disclosure, the control unit is configured to determine power demand of the first electronic device and the second electronic device in response to a key-off signal of the vehicle being received, and control the first relay and the second relay to supply power according to the power demand.

In the power system of at least one embodiment of the present disclosure, the first low-voltage battery further comprises a first switching element connecting the first output line and the first cell module and a second switching element connecting the second output line and the second cell module, and the control unit is further configured to control the first switching element and the second switching element according to the power demand.

In the power system of at least one embodiment of the present disclosure, the control unit is further configured to switch the first relay on and switch the second relay off in response to the power demand when there is a power demand of the first electronic device and there is no power demand of the second electronic device, and switch the second relay on and switch the first relay off in response to the power demand when there is a power demand of the second electronic device and there is no power demand of the first electronic device.

The power system of at least one embodiment of the present disclosure further comprises a second low-voltage battery, wherein the control unit is further configured to determine a state of the second low-voltage battery and determine accordingly whether to supply the power.

In the power system of at least one embodiment of the present disclosure, the control unit is further configured to charge the first low-voltage battery according to an SoC of the first low-voltage battery detected through a cell monitoring unit in response to a key-on signal of the vehicle being received.

In the power system of at least one embodiment of the present disclosure, the control unit is further configured to perform switching on the first relay and charging the first cell module, and/or switching the second relay on and charging the second cell module.

The power system according to at least one embodiment of the present disclosure further comprises a first capacitor configured to block a surge current occurred due to an electrical connection switching of the first relay and a second capacitor configured to block a surge current occurred due to an electrical connection switching of the second relay.

The power system of at least one embodiment of the present disclosure further comprises an intelligent power switching element connected to the first connection line or the second connection line.

According to another embodiment of the present disclosure, a method for controlling a power system of a vehicle includes determining a power demand of the first electromagnetic device and the second electronic device in response to a key-off signal of the vehicle being received, and controlling the first relay and the second relay and supplying power according to the power demand, wherein the power system comprises a first connection line connected to a first low-voltage DC-DC converter and/or a first electronic device, a second connection line connected to a second low-voltage DC-DC converter and/or a second electronic device, a first relay connected to the first connection line, a second relay connected to the second connection line, a control unit configured to control the first relay and the second relay, and a first low-voltage battery, and the first low-voltage battery comprises a first cell module comprising a first output line, a second output line, a first cell module comprising a plurality of first cells and configured to output a first voltage to the first output line, and a second cell module comprising a plurality of second cells and connected to the first cell module in serial connection to output the second voltage to the second output line.

In the method of at least one embodiment of the present disclosure, the first low-voltage battery further comprises a first switching element connecting the first output line and the first cell module and a second switching element connecting the second output line and the second cell module, and wherein the supplying the power includes controlling the first switching element and the second switching element according to the power demand.

In the method of at least one embodiment of the present disclosure, supplying the power includes switching the first relay on and switching the second relay off in response to the power demand when there is a power demand of the first electronic device and there is no power demand of the second electronic device, and switching the second relay on and switching the first relay off in response to the power demand when there is a power demand of the second electronic device and there is no power demand of the first electronic device.

In the method of at least one embodiment of the present disclosure, the power system further comprises a second low-voltage battery, and the method further includes determining a state of the second low-voltage battery and determining whether to perform the supplying the power according to the state of the second low-voltage battery.

The method of at least one embodiment of the present disclosure further includes performing power charging for the first low-voltage battery according to the SoC of the first low-voltage battery detected through the cell monitoring unit as the key-on signal of the vehicle is received.

In the method of at least one embodiment of the present disclosure, the charging the first low-voltage battery includes switching on the first relay and charging the first cell module, and/or switching on the second relay and charging the second cell module.

According to one embodiment of the present disclosure, it is possible to take measures for redundancy for a plurality of low voltage power sources through one low-voltage battery package.

According to one embodiment of the present disclosure, redundancy solutions for 12 Vs and 24 Vs can be taken with one auxiliary low-voltage battery to reduce material costs and weight. Furthermore, the battery of the present disclosure is selectively dischargeable to improve cell balancing and the guarantee of auxiliary power supply without changes in nominal voltages of 12V and 24V.

According to an exemplary embodiment of the present disclosure, it is possible to obtain a power system capable of supplying emergency power when a problem occurs in power supply of a main low-voltage battery and an electric vehicle thereof.

As discussed, the method and system suitably include use of a controller or processer.

In another embodiment, vehicles are provided that comprise an apparatus as disclosed herein.

### BRIEF DESCRIPTION OF DRAWINGS

FIG. 1 illustrates a battery according to an exemplary embodiment of the present disclosure.

FIG. 2 illustrates a vehicle power system according to an exemplary embodiment of the present disclosure.

FIG. 3 and FIG. 4 are a flowchart showing a controlling method according to an exemplary embodiment of the present disclosure.

### DETAILED DESCRIPTION

Since the present disclosure is modified in various ways and has various embodiments, specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

The suffixes “module” and “unit” used herein are used only for name distinction between elements and should not be construed as being physiochemically divided or separated or assumed that they can be divided or separated.

Terms including ordinals such as “first,” “second,” and the like may be used to describe various elements, but the elements are not limited by the terms. The terms are used only for the purpose of distinguishing one element from another element.

The term “and/or” is used to include any combination of a plurality of items to be included. For example, “A and/or B” includes all three cases such as “A”, “B”, and “A and B”.

When an element is “connected” or “linked” to another element, it should be understood that the element may be directly connected or connected to another element, but another element may exist in between.

The terminology used herein is for the purpose of describing particular embodiments only and is not intended to be limiting of the disclosure. Singular expressions include plural expressions, unless the context clearly indicates otherwise. In the present application, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise defined, all terms used herein, including technical or scientific terms, have the same meaning as that generally understood by those skilled in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

In addition, the terms “unit”, “control unit”, “control device”, or “controller” are terms widely used for naming a controller that commands a specific function, and does not mean a generic function unit.

For example, each unit or control unit may include a communication device communicating with another controller or sensor, a computer-readable recording medium storing an operating system or a logic command, input/output information, and the like, in order to control a function in charge, and one or more processors performing determination, calculation, determination, and the like necessary for controlling a function in charge.

Meanwhile, the processor includes a semiconductor integrated circuit and/or electronic devices that perform at least one or more of comparison, determination, calculation, and determination in order to achieve a programmed function. For example, the processor may be a computer, a microprocessor, a CPU, an ASIC, and a circuitry (logic circuits), or a combination thereof.

In addition, the computer-readable recording medium (or simply referred to as a memory) includes all types of storage devices in which data that can be read by a computer system is stored. For example, the memory may include at least one type of a flash memory of a hard disk, of a microchip, of a card (e.g., a secure digital (SD) card or an eXtream digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

The recording medium is electrically connected to the processor, and the processor retrieves and records data from the recording medium. The recording medium and the processor either may be integrated or may be physically separated.

Hereinafter, the embodiments of the present disclosure will be described in detail with reference to the accompanying drawings.

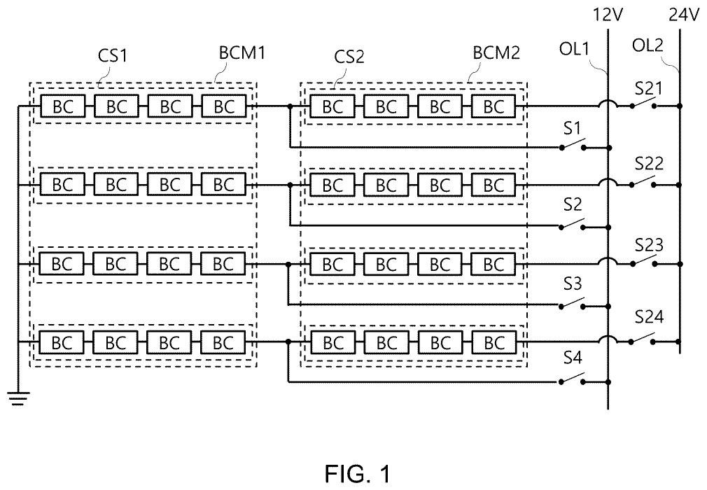

First, referring to FIG. 1, a battery according to an exemplary embodiment of the present disclosure is specified.

The battery may include the first cell module BCM1 and the second cell module BCM2.

The first cell module BCM1 may include a plurality of first cells, and the second cell module BCM2 includes a plurality of second cells.

Both the first cell and the second cell may be battery cells BC of the same type, but the present disclosure is not limited thereto.

For example, the battery cell BC may be a lithium battery cell that outputs a voltage in the range of 2.7 to 4.2 V; however, the present disclosure is not limited thereto.

The first cell module BCM1 may include a plurality of first cell sets CS1 connected in parallel, and one first cell set CS1 may be formed by connecting four battery cells BC in series.

Similarly, the second cell module BCM2 may include a plurality of second cell sets CS2 connected in parallel, and one second cell set CS2 may be formed by connecting four battery cells BC in series.

One first cell set CS1 may be connected in series with one second cell set CS2, and the second cell sets CS2 may output the second voltage of 24V to the second output line OL2.

A power line may be branched from a serial connection line of each of the first cell set CS1 and the corresponding second cell set CS2 to output the first voltage of 12V to the first output line OL1.

The first switching elements (S1 to S4) may be installed between the first cell set CS1 and the first output line OL1 to switch the electrical connection, and the second switching elements (S21 to S24) may be installed between the second cell set CS2 and the second output line OL2 to switch the electrical connection.

When all of the first switching elements (S1 to S4) are switched on, 12V may be output to the first output line OL1, and when all of the second switching elements (S21 to S24) are switched on, 24V may be output to the second output line OL2.

In the present embodiment, the first cell module BCM1 and the second cell module BCM2 each may have an arrangement of battery cells BC of 4S4P, but this is not necessarily limited thereto. The configuration may be altered according to the first voltage, the second voltage, or the output voltage of the battery cell BC.

In addition, although not shown, the battery according to the present embodiment may include a control circuit for controlling the first switching elements (S1 to S4) and the second switching elements (S21 to S24).

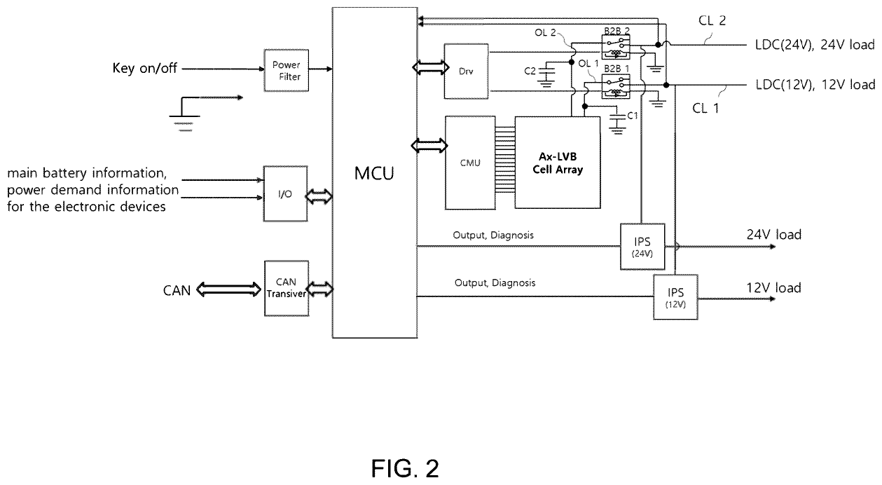

FIG. 2 illustrates a vehicle power system according to an exemplary embodiment of the present disclosure, which will be described in detail below.

First, the vehicle power system of the present embodiment includes a control unit MCU, an auxiliary low voltage battery Ax-LVB as a first low-voltage battery, the first relay B2B1, the second relay B2B2, a cell monitoring unit CMU, among others.

Although not shown, the vehicle power system of the present embodiment may further include a main low-voltage battery, the first low voltage DC-DC converter, and the second low-voltage DC-DC converter as a high-voltage battery and the second low-voltage battery for supplying power to the driving motor of the vehicle. Here, the main low-voltage battery includes the first main low-voltage battery of the first voltage and the second main low-voltage battery of the second voltage.

Meanwhile, in the present embodiment, various electronic devices including an autonomous driving controller may be included in the vehicle, and the electronic devices comprises the first electronic device operated by power of the first voltage and the second electronic device operated by power of the second voltage. Here, the first voltage is 12 V and the second voltage is 24 V, but the present disclosure is not limited thereto.

The auxiliary low-voltage battery Ax-LVB of the present embodiment may be the same as the battery of FIG. 1 and is used for auxiliary power, i.e., redundancy power, in emergency situations in which the power from the first main low-voltage battery or the second main low-voltage battery is unavailable.

A cell monitoring unit CMU may be included to monitor the state of the auxiliary low-voltage battery Ax-LVB. The CMU transmits a monitoring signal to the control unit MCU.

A plurality of CMUs may be provided, and each CMU may be directly attached to the battery cell BC to sense voltage, current, temperature, etc. The CMU may not perform an operation related to a battery management system algorithm, and may simply perform a sensing function. A plurality of battery cells BC may be connected to one CMU, and information of each of the battery cells BC are transferred to the control unit MCU.

The first relay B2B1 may switch an electrical connection between the first output line OL1 of the auxiliary low-voltage battery Ax-LVB and the first connection line CL1, and the second relay B2B2 may switch an electrical connection between the second output line OL2 of the auxiliary low-voltage battery Ax-LVB and the second connection line CL2. To this end, a driver Drv driven by the control unit MCU may be included.

The first connection line CL1 may be connected to the first low-voltage DC-DC converter and the first electronic devices, and the second connection line CL2 may be connected to the second low-voltage DC-DC converter and the second electronic devices.

Therefore, in the case of emergency power supply, when the first relay B2B1 or the second relay B2B2 is switched on, the power of the auxiliary low-voltage battery Ax-LVB may be supplied to the first electronic device or the second electronic device. In addition, when the auxiliary low-voltage battery Ax-LVB needs to be charged, when the first relay B2B1 or the second relay B2B2 is switched “on”, the power of the high-voltage battery may be supplied as the charging power of the auxiliary low-voltage battery Ax-LVB through the first low-voltage DC-DC converter or the second low-voltage DC-DC converter.

Meanwhile, the first capacitor C1 and the second capacitor C2 may be added to block surge currents resulting from sudden blocking of power by the first relay B2B1 and the second relay B2B2.

In addition, an intelligent power switching device ISP may be used for a component requiring more intelligent power supply capable of diagnosis and output control.

The control unit MCU may receive key-on or key-off information, and may also receive main low-voltage battery information and power demand information of the first electronic devices and the second electronic devices.

The key-on or key-off information may be directly received through a key switch (ignition switch or start switch) of the vehicle or may be received through a vehicle controller.

The main low voltage battery information may include state of charge SoC of the first main low-voltage battery and the second main low-voltage battery, information of malfunction, etc.

In the present embodiment, the first main low-voltage battery and the second main low-voltage battery may be lead acid batteries, but they are not limited thereto.

An Intelligent Battery Sensor (IBS) may be included to measure voltage, current, temperature, lifespan, and other parameters of the first and the second main low-voltage batteries. The control unit MCU may directly receive the information from the Intelligent Battery Sensor or indirectly through the vehicle controller.

Also, the MCU may directly receive the power demand information from the first and second electronic devices or may alternatively receive this information through the vehicle controller.

The high-voltage battery of the present embodiment that is not shown may include a plurality of lithium battery cells BC that output a voltage within a range of, e.g., 2.7 to 4.2 V, and output a required voltage, e.g., roughly 400 V, roughly 800 V, or several kV.

In the power system of the present embodiment, under normal operating conditions, the power of the high-voltage battery may be converted through the first low-voltage DC-DC converter and the second low-voltage DC-DC converter while driving the vehicle and supplied to the first electronic devices and the second electronic devices. In addition, this power is used as charging power to the first main low-voltage battery or the second main low-voltage battery through the first low-voltage DC-DC converter and the second low-voltage DC-DC converter according to the SoC state of the first main low-voltage battery or the second main low-voltage battery during vehicle operation.

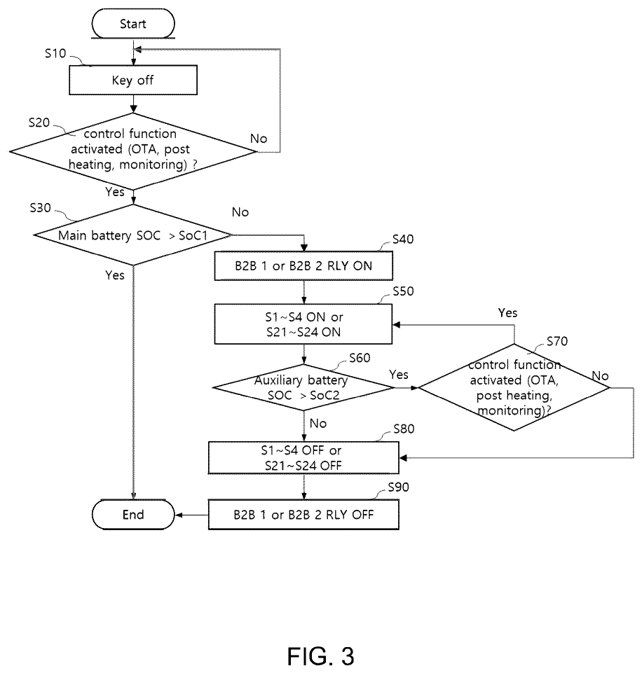

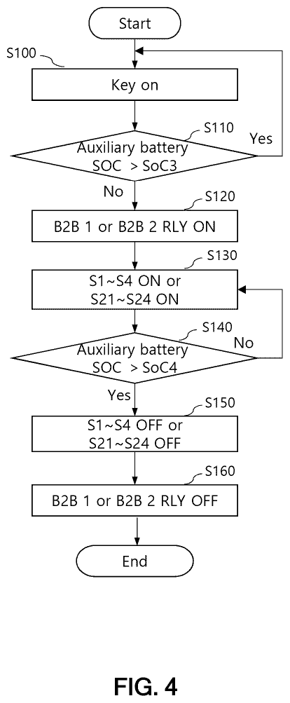

However, in emergency situations such as when the SoC of the first main low-voltage battery or the second main low-voltage battery falls below a predetermined value or when a malfunction prevents power supply, the auxiliary low-voltage battery Ax-LVB may be utilized. The control process by the control unit MCU in such scenarios will be described in detail with reference to FIGS. 3 and 4.

First, in S10, the control unit MCU may receive a key-off signal.

Accordingly, the control unit MCU may determine the power demand of the first electronic device and the power demand of the second electronic device as in S20.

When the power demand of the first electronic device or the second electronic device is checked in S20, the control unit MCU may determine whether the SoC of the first main low-voltage battery or the second main low-voltage battery exceeds the first set SoC in S30. In the present embodiment, the first set SoC for the first main low-voltage battery and the second main low-voltage battery may be the same, but the present disclosure is not limited thereto.

Following the determination in S30, when the SoC of the first main low-voltage battery or the second main low-voltage battery is equal to or less than the first set SoC (No in S30), the control unit MCU may control the driver Drv to switch on either the first relay B2B1 or the second relay B2B2 in S40.

In S50, the control unit MCU may switch on the first switching elements (S1 to S4) or the second switching elements (S21 to S24) of the auxiliary low-voltage battery Ax-LVB.

For example, when it is determined that the SoC of the first main low-voltage battery is equal to or less than the first set SoC as in S30, the first relay B2B1 may be switched “on” in S40, and the first switching elements (S1 to S4) may be switched “on” in S50.

Accordingly, the power of 12V may be supplied from the auxiliary low-voltage battery Ax-LVB to the first electronic devices instead of the first main low-voltage battery.

Also, when it is determined that the SoC of the second main low-voltage battery is equal to or less than the first set SoC in S30, the second relay B2B2 may be switched “on” as in S40, and the second switching elements (S21 to S24) may be switched “on” in S50.

Accordingly, power of 24V may be supplied from the auxiliary low-voltage battery Ax-LVB to the second electronic devices instead of the second main low-voltage battery.

While the power supply is performed as described above, the control unit MCU may determine whether the SoC of the auxiliary low-voltage battery Ax-LVB reaches the second set SoC in S60. Here, the second configuration SoC for the first cell module BCM1 may be the same as the second configuration SoC for the second cell module BCM2, but the present embodiment of the present disclosure is not limited thereto.

If it is determined that the SoC of the auxiliary low voltage battery Ax-LVB has reached the second set SoC, the control unit MCU may switch the first switching elements (S1 to S4) or the second switching elements (S21 to S24) to an off state as in S80 to prevent further discharging.

In S90, the control unit MCU may switch the first relay B2B1 or the second relay B2B2 “off”.

For example, in the case where power of 12V is output from the auxiliary low-voltage battery Ax-LVB and used throughout S40 and S50 as the auxiliary low-voltage battery Ax-LVB reaches the second set SoC, the first switching elements (S1 to S4) and the first relay B2B1 may be switched “off” in S80 and S90.

In addition, when power of 24V is output and used from the auxiliary low-voltage battery Ax-LVB throughout S40 and S50, and when the auxiliary low-voltage battery Ax-LVB reaches the second set SoC, the second switching elements (S21 to S24) and the second relay B2B2 may be switched “off” in S80 and S90.

Meanwhile, even if the auxiliary low-voltage battery Ax-LVB does not reach the second set SoC as the use of the corresponding electronic devices is terminated (No in S70), the process may proceed to S80 to block the discharging of the auxiliary low-voltage battery Ax-LVB.

Hereinafter, the controlling method for the key switch in the key-on state will be described.

First, in S100, the control unit MCU may receive the key-on signal.

Next, in S110, the control unit MCU may check whether the SoC of the auxiliary low-voltage battery Ax-LVB exceeds the third set value.

In S110, when it is determined that the SoC of the auxiliary low-voltage battery Ax-LVB reaches the third set SoC, the control unit MCU may perform a process for charging.

To this end, the control unit MCU may turn on the first relay B2B1 or the second relay B2B2 in S120.

Accordingly, in S130, the control unit MCU may switch on the first switching elements (S1 to S4) or the second switching elements (S21 to S24).

Throughout S120 and S130, the auxiliary low-voltage battery Ax-LVB may be supplied with charging power from the first low-voltage DC-DC converter or the second low-voltage DC-DC converter. When the SoC of the auxiliary low-voltage battery Ax-LVB reaches the fourth set SoC (Yes in S140), the control unit MCU will stop charging.

In order to terminate charging, the control unit MCU may switch the first switching elements (S1 to S4) or the second switching elements (S21 to S24) “off” in S150, and switch the first relay B2B1 or the second relay B2B2 off in S160.

What is claimed is:

1. A battery, comprising:
a first output line;
a second output line;
a first cell module comprising a plurality of first cells and configured to output a first voltage to the first output line;
a second cell module comprising a plurality of second cells and connected to the first cell module in serial connection and configured to output a second voltage to the second output line;
a first switching element electrically coupling the first output line to the first cell module; and
a second switching element electrically coupling the second output line to the second cell module.

2. The battery of claim 1, wherein the first cell module comprises a first cell set comprising the first cells in serial connection to output the first voltage to the first output line, and wherein the second cell module comprises a second cell set connected to the first cell set in serial connection and comprising the second cells in serial connection to output the second voltage to the second output line.

3. The battery of claim 2, wherein the first cell set comprises a plurality of first cell sets connected in parallel, and the second cell set comprises a plurality of second cell sets connected in parallel.

4. A vehicle comprising the battery of claim 1.

5. A power system for a vehicle, the system comprising:
a first connection line connected to a first low-voltage DC-DC converter and/or a first electronic device;
a second connection line connected to a second low-voltage DC-DC converter and/or a second electronic device;
a first relay connected to the first connection line;
a second relay connected to the second connection line;
a control unit configured to control the first relay and the second relay; and
a first battery comprising:
a first output line,
a second output line,
a first cell module comprising a plurality of first cells and configured to output a first voltage to the first output line, and
a second cell module comprising a plurality of second cells and connected to the first cell module in serial connection and configured to output a second voltage to the second output line.

6. The power system of claim 5, wherein the first cell module comprises a first cell set comprising the first cells in serial connection to output the first voltage to the first output line, and the second cell module comprises a second cell set connected to the first cell set in serial connection and comprising the second cells in serial connection to output the second voltage to the second output line.

7. The power system of claim 6, wherein the first cell set comprises a plurality of first cell sets connected in parallel, and the second cell set comprises a plurality of second cell sets connected in parallel.

8. The power system of claim 5, wherein the control unit is configured to determine power demand of the first electronic device and the second electronic device in response to a key-off signal of the vehicle being received, and control the first relay and the second relay to supply power according to the power demand.

9. The power system of claim 8, wherein the first battery further comprises a first switching element connecting the first output line and the first cell module and a second switching element connecting the second output line and the second cell module, and the control unit is further configured to control the first switching element and the second switching element according to the power demand.

10. The power system of claim 8, wherein the control unit is further configured to switch the first relay on and switch the second relay off in response to the power demand when there is a power demand of the first electronic device and there is no power demand of the second electronic device, and switch the second relay on and switch the first relay off in response to the power demand when there is a power demand of the second electronic device and there is no power demand of the first electronic device.

11. The power system of claim 8 further comprising a second battery, wherein the control unit is further configured to determine a state of the second battery and determine accordingly whether to supply the power.

12. The power system of claim 8, wherein the control unit is further configured to charge the first battery according to an SoC of the first battery detected through a cell monitoring unit in response to a key-on signal of the vehicle being received.

13. The power system of claim 12, wherein the control unit is further configured to perform switching on the first relay and charging the first cell module, and/or switching the second relay on and charging the second cell module.

14. The power system of claim 5 further comprising a first capacitor configured to block a surge current occurred due to an electrical connection switching of the first relay and a second capacitor configured to block a surge current occurred due to an electrical connection switching of the second relay.

15. A method for controlling a power system of a vehicle, wherein the power system comprises a first connection line connected to a first low-voltage DC-DC converter and/or a first electronic device, a second connection line connected to a second low-voltage DC-DC converter and/or a second electronic device, a first relay connected to the first connection line, a second relay connected to the second connection line, a control unit configured to control the first relay and the second relay, and a first battery, and the first battery comprises a first cell module comprising a first output line, a second output line, a first cell module comprising a plurality of first cells and configured to output a first voltage to the first output line, and a second cell module comprising a plurality of second cells and connected to the first cell module in serial connection to output the second voltage to the second output line, the method comprising:
determining a power demand of the first electromagnetic device and the second electronic device in response to a key-off signal of the vehicle being received; and
controlling the first relay and the second relay and supplying power according to the power demand.

16. The method of claim 15, wherein the first battery further comprises a first switching element connecting the first output line and the first cell module and a second switching element connecting the second output line and the second cell module, and
wherein the supplying the power comprises controlling the first switching element and the second switching element according to the power demand.

17. The method of claim 15, wherein supplying the power comprises switching the first relay on and switching the second relay off in response to the power demand when there is a power demand of the first electronic device and there is no power demand of the second electronic device, and switching the second relay on and switching the first relay off in response to the power demand when there is a power demand of the second electronic device and there is no power demand of the first electronic device.

18. The method of claim 15, wherein the power system further comprises a second battery, and the method further comprises determining a state of the second battery and determining whether to perform the supplying the power according to the state of the second battery.

19. The method of claim 15, further comprising charging the first battery according to an SoC of the first battery detected through a cell monitoring unit in response to a key-on signal of the vehicle being received.

20. The method of claim 19, wherein the charging the first battery comprises switching on the first relay and charging the first cell module, and/or switching on the second relay and charging the second cell module.
